(19) United States
(12) Patent Application Publication
(10) Pub. No.: US 2023/0136799 A1
(43) Pub. Date: May 4, 2023

(54) CLOTHING TREATMENT APPARATUS

(71) Applicant: LG ELECTRONICS INC., Seoul (KR)

(72) Inventors: Woore KIM, Seoul (KR); Injae HAN, Seoul (KR); Sangwook HONG, Seoul (KR)

(73) Assignee: LG ELECTRONICS INC., Seoul (KR)

(21) Appl. No.: 17/912,352

(22) PCT Filed: Mar. 18, 2021
(86) PCT No.: PCT/KR2021/003370

§ 371 Date: Sep. 16, 2022

(30) Foreign Application Priority Data
Mar. 18, 2020 (KR) 10-2020-0033142
Mar. 18, 2021 (KR) 10-2021-0035305

(51) Int. Cl. D06F 58/26; D06F 58/04; D06F 58/38

(52) U.S. Cl. CPC D06F 58/26; D06F 58/04; D06F 58/38; D06F 2103/16

(57) ABSTRACT

A clothing treatment apparatus includes a cabinet; a container having a front surface having an opening, a rear surface having an exhaust port, and a body extending between the front surface and the rear surface; a drum in the container; an induction heater is arranged on an outer surface of the body of the container to heat the drum; a supply duct arranged on an outer side of the container and including an outlet portion connected to the front surface of the container; an exhaust duct connected to the supply duct and in communication with the exhaust port; and a ventilation portion for generating the air flow from the exhaust duct toward the supply duct. The front surface of the container includes an inlet port located outside the opening and the outlet portion of the supply duct is in communication with the inlet port of the container.

### TECHNICAL FIELD

The disclosure relates to a clothing treatment apparatus.

### BACKGROUND ART

Generally, a clothing treatment apparatus may include a washing machine, a dryer, an apparatus for refreshing clothing, etc. The washing machine may be a washer-dryer combo having a drying function.

The washing machine removes contaminants from laundry accommodated in a drum by rotating the drum in a tub where water is stored. The washing machine may be provided with a heating means for heating water or drying laundry.

The dryer rotates the drum in a cabinet and applies heat to laundry in the drum to dry the laundry.

The clothing treatment apparatus may include a heating means for heating or drying laundry. The clothing treatment apparatus may be provided with an electric heater or a heat pump as the heating means.

Recently, research on an induction module as a new heating means is being conducted.

Moreover, in the case of using the clothing treatment apparatus as the dryer using an induction heating module, an exhaust-type drying method in which wet air is discharged to the outside and dry air is sucked in or a circulation-type drying method in which air inside a tub is circulated to remove the wet air may be used.

The exhaust-type drying method does not need to consider a problem caused by the generation of condensate, but requires communication with the outside, so that there are additional restrictions such as an installation place.

In the case of the conventional circulation-type drying method, the generation of condensate is unavoidable when wet air is replaced with dry air. Since the clothing treatment apparatus using the induction module directly heats not washing water but a drum, the drum may be unnecessarily cooled by condensate when the condensate is scattered onto the drum. That is, when the condensate is scattered onto the drum, it is disadvantageous in terms of heat exchange efficiency.

Korean Patent Laid-Open Publication No. 10-2018-0023276 has disclosed a structure on which a coil is wound, but contents of condensate condensed through drying using this structure are not disclosed.

### SUMMARY

The present disclosure aims to solve the above and other problems.

Another objective is to provide a clothing treatment apparatus, such as a dryer, a washing machine, a washer-dryer combo or an apparatus for refreshing clothing, which can circulate air inside a drum.

A further objective is to provide a clothing treatment apparatus capable of improving drying efficiency.

Another objective is to provide a clothing treatment apparatus provided with an induction heating means.

Another objective is to provide a clothing treatment apparatus, in which condensate of a duct through which air of a tub is circulated is not scattered onto a drum.

Another objective is to provide a clothing treatment apparatus, in which air directed from a duct to a tub exchanges heat with a heated drum and then flows into the drum.

Another objective is to provide a clothing treatment apparatus, in which air directed from a duct to a tub is dispersed and then flows to a drum.

Another objective is to provide a clothing treatment apparatus, in which air directed from a duct to a tub flows between a drum and the tub.

Another objective is to provide a clothing treatment apparatus, in which air present between a tub and a drum can be introduced through a hole of the drum into the drum.

Another objective is to provide a clothing treatment apparatus, in which water condensed in a duct is discharged to the outside.

In order to accomplish the above objectives, a clothing treatment apparatus according to an aspect of the present disclosure includes a drum, an induction heater for heating the drum, and a duct for providing a flow path in which air of a container is circulated.

The clothing treatment apparatus includes a container in which the drum is arranged.

The container may include a front surface having an opening. The opening may be located in a central portion of the front surface. The front surface may have a ring shape.

The container may include a rear surface having an exhaust port. The exhaust port may be located in a lower side of the rear surface of the container.

The container may include a body extending between the front surface and the rear surface. The body may have the shape of an elongated cylinder.

The clothing treatment apparatus may include a cabinet.

The container may be provided in the cabinet.

The clothing treatment apparatus may be a washing machine or a washer-dryer combo. In this case, the container may be a tub. The tub may provide a space for accommodating water. The tub may accommodate the drum.

The drum may be provided in the container. The drum may be rotatably provided in the container. The drum may provide a space for accommodating laundry. The drum may accommodate laundry. The drum may be formed of metal.

The drum may include a body having the shape of an elongated cylinder. The drum may include a hole formed in the body. The drum may include a drum front portion connected to a front end of the drum body. The drum front portion may have a drum opening.

The induction heater may be disposed on an outer surface of the container. The induction heater may be spaced apart from the drum and be secured to the container. The induction heater may be located on an upper side of the container body.

The induction heater may include a coil. The induction heater may heat the drum through a magnetic field generated when a current is applied to the coil. The induction heater may heat the drum body facing the coil. The drum may be rotated and the induction heater may be secured to the container to heat the entire drum body. The induction heater may heat the drum body as well as both a drum front portion and rear portion by heat conduction.

The duct may be disposed on an outer side of the container.

The clothing treatment apparatus may include a supply duct disposed on the outer side of the container. The supply duct may extend along the body of the container. The supply duct may include an outlet portion connected to the front surface of the container.

The clothing treatment apparatus may include an exhaust duct connected to the supply duct. The exhaust duct may be directly connected to the supply duct or be connected to the supply duct through another component. The exhaust duct may communicate with the exhaust port of the container.

The clothing treatment apparatus may include a ventilation portion which generates an air flow from the exhaust duct toward the supply duct. The ventilation portion may be located between the exhaust duct and the supply duct. The ventilation portion may connect the exhaust duct and the supply duct.

The front surface of the container may include an inlet port. The inlet port may communicate with the outlet portion of the supply duct.

The outlet portion of the supply duct may communicate with the inlet port of the container. The outlet portion may include an exit which extends rearward to be connected to the inlet port of the container.

The inlet port of the container may be located on the outer side of the opening. The inlet port may be located on the upper side of the opening.

The inlet port of the container may face the drum front portion.

The drum front portion may include an inclined surface which is inclined outward and rearward at a position corresponding to the inlet port of the container.

The drum front portion may include an extending portion which extends forward to provide the drum opening.

The inlet port of the container may be located behind the drum opening.

The exhaust port of the container may be located on the lower side of the container rear surface.

The exhaust duct may extend upward from the exhaust port.

The clothing treatment apparatus may further include a heat exchange portion disposed inside the exhaust duct. The heat exchange portion may absorb heat from air discharged from the container.

The clothing treatment apparatus may further include a condensate discharge portion disposed on the lower side of the exhaust duct.

The clothing treatment apparatus may further include a temperature sensor located on the upper portion of the container. The temperature sensor may be located between the container and the drum. The temperature sensor may be located behind the center of the container in a longitudinal direction thereof.

An embodiment provides a clothing treatment apparatus including a cabinet, a tub provided in the cabinet, a drum rotatably provided in the tub to accommodate laundry and formed at least partially of a metal material, an induction module provided on an outer surface of the tub and heating an outer surface of the drum through a magnetic field generated when a current is applied to a coil, a supply duct communicating with a front surface of the tub to extend to a rear side of the tub, an exhaust duct communicating with a rear of the tub to extend along a rear surface of the tub, and a ventilation portion introducing air through the supply duct into the tub. The supply duct is provided to form an air flow introduced between an inner circumference of the tub and an outer circumference of the drum during drying, the air introduced between the inner circumference of the tub and the outer circumference of the drum is heated by the induction module, and the heated air exchanges heat with the laundry and then is discharged to the exhaust duct.

Further, the clothing treatment apparatus includes a heat exchange portion for condensing air which is subjected to heat exchange in the exhaust duct.

Further, the exhaust duct communicates with the tub in a lower side of a rear portion of the tub.

Further, a condensate discharge portion is formed in the exhaust duct to guide condensate to the lower side of the tub or a drain pipe and thereby prevent the scattering of the condensate.

Further, the clothing treatment apparatus includes a ventilation portion communicating with the supply duct and the exhaust duct, and the ventilation portion is provided to guide air passing through the exhaust duct to the supply duct.

Further, the clothing treatment apparatus includes an induction cooling path communicating with the ventilation portion and the induction module, and the ventilation portion includes a first fan provided to circulate air from the exhaust duct to the supply duct, and a second fan provided in the induction cooling path to blow air into the induction module.

Further, the first fan and the second fan are rotated via a ventilation-portion motor.

Further, the first fan and the second fan are provided to rotate about the same rotating axis.

### Advantageous Effects

In accordance with at least one of embodiments of the present disclosure, an induction heating principle is applied without directly heating water, so that it is excellent in energy efficiency.

Further, a ventilation portion generates an air flow from an exhaust duct to a supply duct, so that it is possible to prevent condensate of a duct from being scattered.

Further, it is possible to prevent the temperature drop of the drum by preventing the scattering of the condensate. Furthermore, it is possible to improve drying efficiency by preventing the temperature drop of the drum due to the scattering of the condensate.

Further, a supply duct is connected to a front surface of a container or a tub, thus reducing the amount of low-temperature air flowing into the drum.

Further, the supply duct may be connected to the front surface of the container or the tub to guide the low-temperature air between the drum and the container (or the tub). Further, the drying efficiency can be improved by reducing the amount of low-temperature air flowing into the drum and introducing high-temperature air into the drum.

Further, the inlet port of the container may face the drum front portion so that air introduced into the inlet port may be dispersed while surrounding the drum.

Further, the introduced air is dispersed, so that a heat exchange area can be increased. Furthermore, energy efficiency can be improved due to an increase in heat exchange area.

Further, the drum front portion includes an inclined surface at a position corresponding to the inlet port, so that the introduced air may be guided between the container body and the drum body. Further, the air introduced into the inlet port is guided between the container body and the drum body to improve ventilation efficiency. It is possible to improve heat transfer efficiency by convection due to improvement in ventilation efficiency.

Further, the inlet port is located on an upper portion of the front surface so that a relatively large amount of air may be introduced into the upper portion of the drum body and the upper portion of the container body, and a hole formed in the upper portion of the drum body is not closed by laundry, so that heated air can be easily introduced into the drum.

Further, the heat exchange portion is located in the exhaust duct, the exhaust duct extends upward, and the condensate discharge portion is located in the lower side of the exhaust duct, so that condensed water may be discharged to the outside without flowing back into the container.

### BRIEF DESCRIPTION OF THE DRAWINGS

FIG. 1 is a sectional view illustrating a clothing treatment apparatus according to an embodiment.

FIG. 2 is an exploded perspective view illustrating an induction module of the clothing treatment apparatus according to the embodiment.

FIG. 3 is a perspective view illustrating an interior of a cabinet according to the embodiment.

FIG. 4 is a partial enlarged sectional view of a tub according to the embodiment.

FIG. 5 is a diagram illustrating a flow in an exhaust duct according to the embodiment.

FIG. 6 is a diagram illustrating an air circulation structure according to the embodiment.

### DESCRIPTION OF EXEMPLARY EMBODIMENTS

Hereinafter, embodiments of the present disclosure will be described in detail with reference to the accompanying drawings. The same reference numerals are used throughout the drawings to designate the same or similar components, and a duplicated description thereof will be omitted.

The suffixes “module” and “unit” for components used in the following description are given or used in consideration of only the ease of describing the specification, and do not have distinct meanings or roles.

When it is determined that the detailed description of the known art related to an embodiment disclosed in the specification may be obscure the gist of the embodiment, the detailed description thereof will be omitted. Further, it is to be understood that the accompanying drawings are merely for making those skilled in the art easily understand the embodiment disclosed herein, the technical spirit of the present disclosure is not limited to the accompanying drawings, and the present disclosure covers various alternatives, modifications, equivalents and other embodiments that fall within the spirit and scope of the present disclosure.

Although the terms “first”, “second”, etc. may be used herein to describe various components, these components should not be limited by these terms. These terms are only used to distinguish one component from another component.

It should be understood that when a component is referred to as being “coupled” or “connected” to another component, it can be directly coupled or connected to the other component or intervening components may be present therebetween. In contrast, it should be understood that when a component is referred to as being “directly coupled” or “directly connected” to another component, there are no intervening components present.

Herein, the singular forms are intended to include the plural forms as well, unless the context clearly indicates otherwise.

Furthermore, although each drawing is described for the convenience of description, it is apparent to those skilled in the art that other embodiments may be implemented by combining at least two or more drawings without departing from the scope of the present invention.

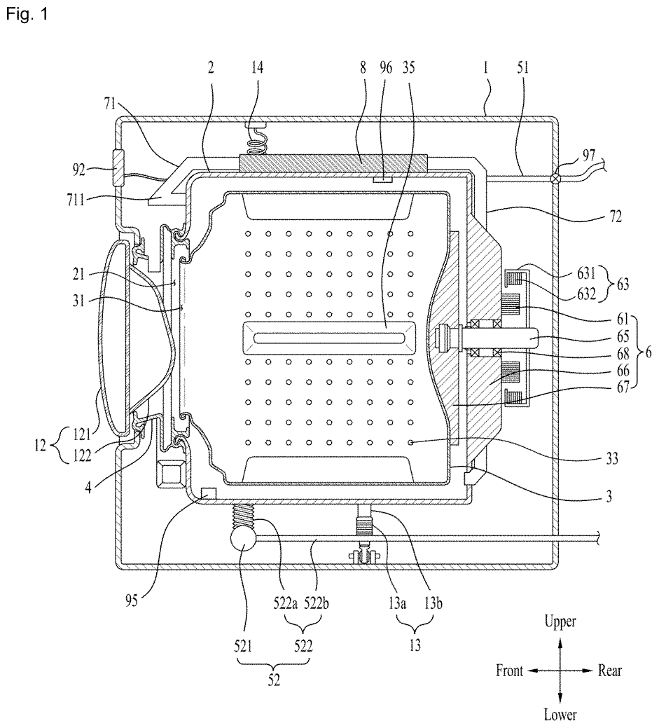

FIG. 1 is a sectional view illustrating a clothing treatment apparatus according to an embodiment.

The clothing treatment apparatus according to an embodiment of the present disclosure may be a washing machine, a dryer, a washer-dryer combo, or a device for refreshing clothing.

The clothing treatment apparatus includes a drum 3 and an induction heater 8 (or induction module) which heats the drum 3.

Further, the clothing treatment apparatus may include a container 2 in which the drum 3 is arranged. The container 2 may include a tub which provides a space for accommodating water and the drum. When the clothing treatment apparatus is the washing machine or the washer-dryer combo, the container 2 may be the tub.

Hereinafter, the washer-dryer combo will be described as a representative example of the clothing treatment apparatus. However, the clothing treatment apparatus of the present disclosure is not limited to the washer-dryer combo. Hereinafter, the container 2 may also be referred to as the tub 2.

The clothing treatment apparatus according to an embodiment of the present disclosure may include a cabinet 1 which defines an appearance, a tub 2 which is provided in the cabinet, and a drum 3 which is rotatably provided in the tub 2 and accommodates an object (e.g., a laundry object, a drying object, or a refresh object). For instance, when clothing is washed by washing water, this may be referred to as the laundry object. When wet clothing is dried using heat, this may be referred to as the drying object. When dry clothing is refreshed using hot air, cool air or steam, this may be referred to as the refresh object. Thus, clothing may be washed, dried or refreshed through the drum 3 of the clothing treatment apparatus.

The cabinet 1 may include a cabinet opening which is provided on the front of the cabinet 1 to allow the object to be put into and taken out from the cabinet. The cabinet 1 may be provided with a door 12 which is rotatably mounted on the cabinet to open or close an input port.

The door 12 may include an annular door frame 121 and an inspection window 122 provided on a central portion of the door frame.

Here, when a direction is defined to help the understanding of the detailed structure of the clothing treatment apparatus which will be described below, a direction facing the door 12 with respect to the center of the cabinet 1 may be defined as a front.

Further, a direction diametrically opposite to the direction facing the door 12 may be defined as a rear, and right and left directions may be naturally defined depending on the above-defined front-rear direction.

The tub 2 is provided in a cylindrical shape with a longitudinal axis thereof being parallel to a lower surface of the cabinet or forming 0 to 30° with the lower surface, thus defining a space in which water may be stored, and has on a front thereof a tub opening 21 to communicate with the input port.

The tub 2 may be fixed to the lower surface (bottom surface) of the cabinet 1 by a lower support portion 13 including a support bar 13a and a damper 13b connected to the support bar 13a. Thus, vibration generated in the tub 2 may be attenuated by the rotation of the drum 3.

Further, an elastic support portion 14 secured to the upper surface of the cabinet 1 may be connected to the upper surface of the tub 2. This may also serve to attenuate vibration generated in the tub 2 and transmitted to the cabinet 1.

The drum 3 is provided in a cylindrical shape with a longitudinal axis thereof being parallel to the lower surface (bottom surface) of the cabinet or forming 0 to 30° with the lower surface, thus accommodating the object, and may have on a front thereof a drum opening 31 communicating with the tub opening 21. An angle between the central axis of the tub 2 and the bottom surface may be the same as an angle between the central axis of the drum 3 and the bottom surface.

Further, the drum 3 may include a plurality of through holes 33 which are provided to pass through the outer circumference. Through the through holes 33, air and washing water may be introduced between the interior of the drum 3 and the interior of the tub 4.

A lifter 35 may be further provided on the inner circumference of the drum 3 to stir the object when the drum is rotated, and the drum 3 may be rotated by a driving portion 6 which is provided in back of the tub 2.

The driving portion 6 may include a stator 61 which is secured to the rear surface of the tub 2, a rotor 63 which is rotated by the electromagnetic action with the stator, and a rotating shaft 65 which passes through the rear surface of the tub 2 to connect the drum 3 and the rotor 63.

The stator 61 may be secured to the rear surface of a bearing housing 66 which is provided on the rear surface of the tub 2, and the rotor 63 may include a rotor magnet 632 which is provided on the outside of the stator in the radial direction, and a rotor housing 631 which connects the rotor magnet 632 and the rotating shaft 65.

A plurality of bearings 68 may be provided in the bearing housing 66 to support the rotating shaft 65.

Further, a spider 67 may be provided on the rear surface of the drum 3 to easily transmit the rotating force of the rotor 63 to the drum 3, and the rotating shaft 65 may be secured to the spider 67 to transmit the rotation power of the rotor 63.

Meanwhile, the clothing treatment apparatus according to an embodiment of the present disclosure may further include a water supply hose 51 supplied with water from the outside, and the water supply hose 51 defines a flow path which supplies water to the tub 2.

Further, a gasket 4 may be provided between the input port of the cabinet 1 and the tub opening 21. The gasket 4 serves to prevent water in the tub 2 from leaking into the cabinet 1 and to prevent the vibration of the tub 2 from being transmitted to the cabinet 1.

Meanwhile, the clothing treatment apparatus according to an embodiment of the present disclosure may further include a drain portion 52 which discharges water in the tub 2 to the outside of the cabinet 1.

The drain portion 52 may include a drain pipe 522 forming a drain path through which water in the tub 2 moves, and a drain pump 521 which generates a pressure difference in the drain pipe 522 to drain water through the drain pipe 522.

In detail, the drain pipe 522 may include a first drain pipe 522a which connects the lower surface of the tub 2 and the drain pump 521, and a second drain pipe 522a which is connected at one end thereof to the drain pump 521 to define a flow path where water moves to the outside of the cabinet 1.

The clothing treatment apparatus according to an embodiment of the present disclosure may further include an induction module 8 which inductively heats the drum 3.

The induction module 8 is mounted on the circumferential surface of the tub 2. The induction module inductively heats the circumferential surface of the drum 3 through a magnetic field generated by applying a current to a coil around which wire is wound. Thus, the heating portion may be referred to as an induction heater. If the induction heater is driven, the outer circumference of the drum opposite to the induction module 8 may be heated to very high temperature within a very short time.

The induction module 8 may be arranged outside or inside the duct 71 or 72.

The induction module 8 may be controlled by a controller 9 which is secured to the cabinet 1. The controller 9 controls the internal temperature of the tub, by controlling the driving of the induction module 8. The controller 9 may include a processor which controls the driving of the clothing treatment apparatus, and may include an inverter processor which controls the induction module. That is, the driving of the clothing treatment apparatus and the driving of the induction module 8 may be controlled through one processor.

However, in order to ensure control efficiency and prevent the overload of the processor, a processor for controlling the driving of the general clothing treatment apparatus and a processor for controlling the induction module 8 may be individually provided, and be communicatively connected to each other.

A temperature sensor 95 may be provided in the tub 2. The temperature sensor 95 may be connected to the controller 9, and transmit information about the internal temperature of the tub 2 to the controller 9. Particularly, the temperature sensor may be provided to sense the temperature of washing water or wet air. Therefore, this may be referred to as a washing-water temperature sensor.

The temperature sensor 95 may be provided near the bottom in the tub. Thus, the temperature sensor 95 may be positioned below the lowermost end of the drum. FIG. 1 shows the temperature sensor 95 provided to be in contact with the bottom surface of the tub. However, the temperature sensor may be preferably provided to be spaced apart from the bottom surface by a predetermined distance. This allows the washing water or air to surround the temperature sensor so that the temperature of the washing water or air is precisely measured. The temperature sensor 95 may be mounted to pass through the tub from the lower portion to the upper portion, but may be mounted to pass through the tub from the front to the rear. That is, the temperature sensor may be mounted to pass through the front surface (surface forming the tub opening) of the tub instead of the circumferential surface thereof.

Therefore, when the clothing treatment apparatus heats the washing water through the induction module 8, the temperature sensor may detect whether the washing water is heated to target temperature. Based on the detected result of the temperature sensor, the driving of the induction heater may be controlled.

Further, when all of the washing water is drained, the temperature sensor 95 may detect the temperature of the air. Since residual washing water or coolant is present in the bottom of the tub, the temperature sensor 95 may sense the temperature of wet air.

Meanwhile, the clothing treatment apparatus according to an embodiment of the present disclosure may include a drying temperature sensor 96. The drying temperature sensor 96 may be different in installation position and temperature measurement target from the above-described temperature sensor 95. The drying temperature sensor 96 may detect the temperature of air heated through the induction module 8, i.e. the drying temperature. Thus, the temperature sensor may detect whether air is heated up to the target temperature. Based on the detected result of the drying temperature sensor, the driving of the induction heater may be controlled.

The drying temperature sensor 96 may be located on the upper portion of the tub 2, and be provided near the induction module 8. That is, the drying temperature sensor may be provided on the inner surface of the tub 2 outside the projection surface of the induction module 8 to detect the temperature of the outer circumference of the opposite drum 3. The above-described temperature sensor 95 may be provided to detect the temperature of the surrounding water or air, and the drying temperature sensor 96 may be provided to detect the temperature of the drum or the drying air temperature around the drum.

Since the drum 3 is configured to rotate, the temperature of the outer circumference of the drum may be indirectly sensed by sensing the temperature of air near the outer circumference of the drum 30.

The temperature sensor 95 may be provided to determine whether to continue the driving of the induction heater up to a target temperature or whether to vary the output of the induction heater. The drying temperature sensor 96 may be provided to determine whether to overheat the drum. When it is determined that the drum is overheated, the driving of the induction heater may be forcibly stopped.

In addition, the clothing treatment apparatus according to an embodiment of the present disclosure may have a drying function. In this case, the clothing treatment apparatus according to an embodiment of the present disclosure may be referred to as a washer-dryer combo.

The drying may be performed using the induction module 8. That is, washing water may be heated during washing, an object may be heated during spin-drying, and an object may be heated during drying, through one induction heater.

When the drum 3 is driven and the induction module 8 is driven, the entire drum 3 may be substantially heated. The heated drum exchanges heat with wet laundry to heat the laundry. Of course, air in the drum may also be heated. Thus, if air is supplied to the interior of the drum 3, air from which water is evaporated through heat exchange may be discharged to the outside of the drum 3.

The supply position of the air and the discharge position of the air may be determined so that heated air is uniformly supplied to the drying object and the wet air is smoothly discharged.

This will be described below in detail.

Thus, since the air itself is not directly heated, the temperature of heating air may be lower than the temperature of heating air in a general heater heating dryer. Therefore, the effect capable of preventing damage or deformation of clothing due to high temperature may be expected.

However, as described above, since the drum is driven, the induction heater is driven, clothing repeatedly rises and falls as the drum is driven, and the heating position of the drum is not at the lower portion but at the upper portion of the drum, the overheating of the clothing can be effectively prevented.

A control panel 92 may be provided on the front surface or upper surface of the clothing treatment apparatus. The control panel may be provided for a user interface. The control panel may perform various user inputs, and display various pieces of information. That is, a manipulation portion for user manipulation and a display portion for displaying information to a user may be provided on the control panel 92.

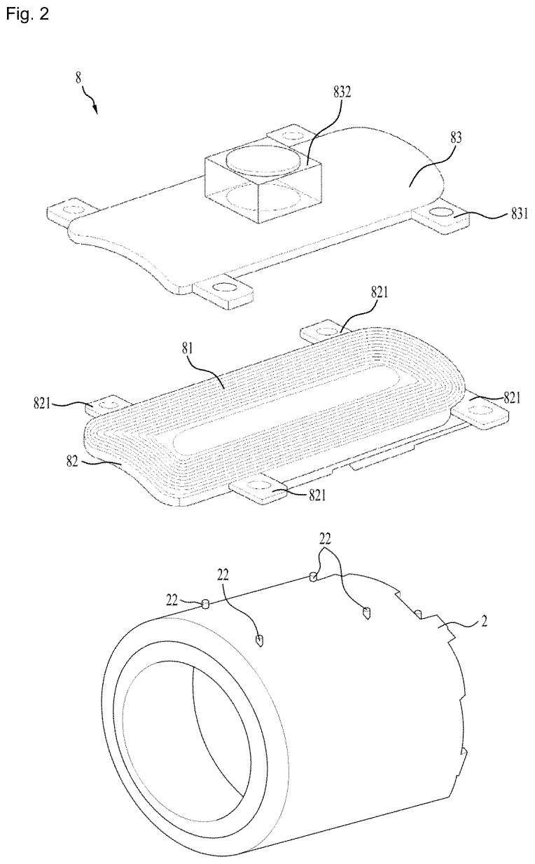

FIG. 2 is an exploded perspective view illustrating an induction module of the clothing treatment apparatus according to the embodiment.

Hereinafter, the induction module of the clothing treatment apparatus according to the embodiment will be described in detail with reference to FIG. 2.

The clothing treatment apparatus according to an embodiment of the present disclosure may be provided with the induction may be provided with the induction module 8 for inductively heating the drum 3. The induction module 8 may heat the drum 3 to heat washing water or dry laundry. The principle of heating the drum 3 using the induction module 8 is as follows.

The induction module 8 is mounted on the outer circumference of the tub 2, and heats the drum 3 through a magnetic field generated by applying a current to the coil 81 around which the wire is wound. The wire may be formed of a core and a coating surrounding the core. The core may be a single core. A plurality of cores may be entangled to form one core. Thus, the thickness or diameter of the wire may be determined by the thickness of the core and coating.

If an alternating current that is changed in phase flows through the coil 81 around which the wire is wound, the coil 81 forms a radial AC magnetic field according to the Ampere's circuital law.

The AC magnetic field concentrates on the drum (metal material) made of a conductor having high magnetic permeability. The magnetic permeability refers to a degree to which a medium is magnetized with respect to a given magnetic field. At this time, according to Faraday's law of induction, an eddy current is formed in the drum 3. The eddy current flows through the drum 3 made of the conductor, and is converted into Joule heat by the resistance of the drum 3 itself, so that the inner wall of the drum 3 is directly heated.

If the inner wall of the drum 3 is directly heated, the temperature of air in the drum 3 and the temperature of laundry contacting the inner wall of the drum 3 are increased together. Therefore, since the laundry may be directly heated, faster drying is possible compared to a drying apparatus using only a hot air drying method that is an indirect heating method, or a low temperature dehumidifying and drying method.

In the case of the clothing treatment apparatus having a washing function, washing water may be heated without a separate heating wire and flow path. Since the washing water continuously contacts the inner and outer walls of the drum 3 heated to a high temperature, it is not necessary to form a separate flow path and heating wire under the tub. According to the above-described method, it is possible to more rapidly heat washing water compared to a method in which the separate flow path and heating wire are formed under the tub and washing water is heated using the flow path and heating wire.

The induction module 8 according to this embodiment may include a coil 81, a base housing 82, and a module cover 83.

The induction module 8 may be provided on the outer surface of the tub 2, and be provided to heat the outer surface of the drum 3 through the magnetic field generated when a current is applied to the coil 81.

Specifically, the induction module 8 may include the base housing 82 which is provided to be spaced apart from the outer surface of the tub 2 by a predetermined distance.

The base housing 82 may be provided to accommodate and support the wound coil 81. The base housing 82 may have a shape corresponding to that of the outer circumference (or circumferential surface) of the tub 2, so that the base housing may be uniformly spaced apart from the tub 2.

Thus, the amount of the magnetic field transmitted through the base housing 82 is not changed depending on the position of the circumferential surface of the tub 2, so that uniform heating is possible.

The tub 2 may include a tub connector 22. The tub connector 22 may be provided to secure the induction module 8 to the circumferential surface of the tub 2. The base housing 82 and the tub 2 may be spaced apart from each other by the length of the tub connector 22.

The base housing 82 may be provided with a housing connector 821 to correspond to the position of the tub connector 22. The tub connector 22 and the housing connector 821 may be coupled to each other, so that the induction module 8 may be secured to the outer circumference of the tub 2.

The coil 81 may be wound and provided in the base housing 82. The coil 81 may be wound along the upper surface of the base housing 82, and may be provided to be slightly shorter in length than the tub 2.

This can prevent other components in the clothing treatment apparatus from being heated.

However, when the length of the coil is excessively shorter than that of the tub 2, it may be difficult to effectively transmit heat. Thus, the coil may be wound to be disposed adjacent to the front surface of the tub 2 and the rear surface of the tub 2.

A module cover 83 may be provided on the upper surface of the coil 81 to correspond to the size of the base housing 82. The module cover 83 may be coupled to the base housing 82 to be mounted on the outer circumference of the tub 2.

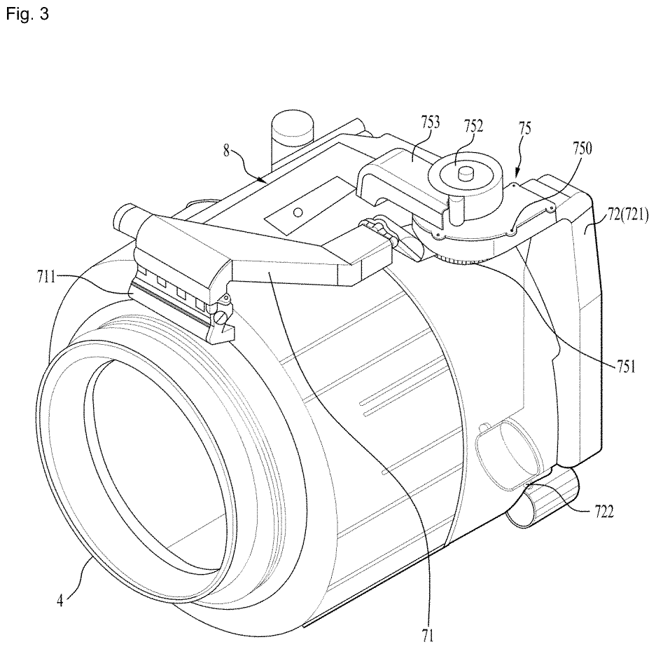

FIG. 3 is a perspective view illustrating an interior of the cabinet according to the embodiment.

An opening 21 (see FIG. 1) may be formed in the front surface of the tub 2, and a gasket 4 may be connected to the opening 21.

The clothing treatment apparatus according to this embodiment may include a supply duct 71 and an exhaust duct 72.

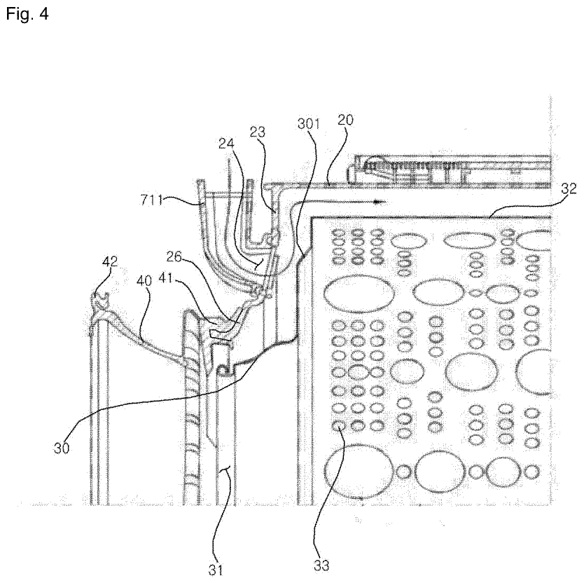

The supply duct 71 may be provided to communicate with the front surface 23 (see FIG. 4) of the tub 2 and extend to the rear of the tub 2.

The supply duct 71 may be provided to communicate with the front surface 23 of the tub 2, extend a predetermined length in a radial direction of the tub 2, and extend from the upper side of the tub 2 to the rear side of the tub 2.

That is, the outlet portion 711 of the supply duct 71 may be provided to extend in the radial direction of the tub 2, and the supply duct 71 may be provided to extend to the rear of the tub 2.

The supply duct 71 may not be provided to immediately put air into the drum 3, but may be provided to introduce a maximum amount of air into a space between the tub 2 and the drum 3.

Further, the air introduced into the tub 2 may be more advantageous for drying if it is heated by the induction module 8.

The air introduced into the tub 2 may become dry air while passing through the exhaust duct 72. The dry air has a higher water content than wet air, but air with a higher temperature has a higher water content than air with a relatively lower temperature if the air has the same dryness.

The supply duct 71 may be connected to the upper side of the front surface 23 of the tub 2. The outlet portion 711 of the supply duct 71 may be connected to the upper side of the front surface 23 of the tub. The air introduced into the tub 2 may be moved to the space between the tub 2 and the drum 3 to exchange heat with the drum 3 which is heated by the induction module 8.

The supply duct 71 may be provided to form the flow of air introduced between the inner circumference of the tub 2 and the outer circumference of the drum 3 during drying. The air introduced between the inner circumference of the tub 2 and the outer circumference of the drum 3 through the supply duct 71 may be heated by the induction module 8. The heated air may be discharged to the exhaust duct 72 after exchanging heat with the laundry (dry load) to remove water from the laundry.

The air introduced into the space between the drum 3 and the tub 2 may flow through a through hole 33 (see FIG. 4) formed in the drum 3 to dry the clothing accommodated in the drum 3.

The ventilation portion 75 may be provided to introduce air through the supply duct 71 into the tub 2.

The ventilation portion 75 may include a ventilation-portion housing 750 and a fan.

The ventilation-portion housing 750 may include a first fan receiving portion 751, and a second fan receiving portion 752. A first fan may be received in the first fan receiving portion 751. A second fan may be received in the second fan receiving portion 752.

The ventilation-portion housing 750 is connected to the supply duct 71 and the exhaust duct 72 which will be described later to provide a path along which air moves.

The fan may generate air flow in a direction from the exhaust duct 72 toward the supply duct 71. The fan may include a first fan and a second fan.

The first fan (received in 751) may be provided to introduce the air discharged from the tub 2 through the exhaust duct 72 into the ventilation portion 75. Here, the first fan may be operated to blow the air introduced from the exhaust duct 72 into the supply duct 71.

That is, the air may be circulated in the order of the tub 2, the exhaust duct 72, the ventilation portion 75, and the supply duct.

The second fan (received in 752) may be provided to blow the air into the induction module 8.

The clothing treatment apparatus according to this embodiment may include an induction cooling path 753 provided to be connected to the ventilation portion 75 and the induction module 8. To be more specific, the induction cooling path 753 may be connected to an induction-cooling-path connector 832 formed on the upper side of the module cover 83 and the ventilation-portion housing 750.

The second fan may be provided in the ventilation-portion housing 750 to communicate with the induction cooling path 753. The air introduced through the exhaust duct 72 may be branched into the induction module 8 and the front surface of the tub 2 to be blown by the operation of the first fan and the second fan.

The first fan and the second fan may be operated through one ventilation-portion motor (not shown).

In detail, in order to rotate the first fan and the second fan with one ventilation-portion motor, the first fan and the second fan may be provided to rotate about the same rotating axis.

Thus, it is possible to cool the induction module 8 without providing a separate motor.

The air passing through the induction module 8 may be discharged to a space between the base housing 82 and the module cover 83 of the induction module 8. The cabinet 1 and the tub 2 are provided to prevent the movement of water, but are not a sealed structure which prevents even the flow of air.

Therefore, the air discharged to the outside of the induction module 8 may be introduced into the tub 2 again.

An exhaust port may be formed in the rear surface of the tub 2. The exhaust port may be located on the lower side of the rear surface.

The exhaust duct 72 may be provided to communicate with the rear of the tub 2 and extend along the rear surface of the tub 2.

In detail, the exhaust duct 72 may be connected to the lower side of the rear of the tub 2 and extend along the rear surface of the tub 2.

A heat exchange portion 721 may be provided in the exhaust duct 72. Thus, if the exhaust duct is connected to the lower side of the rear of the tub 2, it is possible to secure time when wet air passing through the exhaust duct 72 may sufficient heat exchange.

The heat exchange portion 721 may be provided as a separate component such as a heater, or may be provided in the form of a partition wall which separates paths from each other when a separate flow path for cooling is formed in the exhaust duct 72.

That is, the heat exchange portion 721 is not limited to a specific form.

The exhaust duct 72 may include a condensate discharge portion 722.

The wet air passing through the exhaust duct 72 may perform heat exchange with the heat exchange portion 721 to remove condensate. The condensate formed in the exhaust duct 72 may descend toward the lower side of the exhaust duct 72. If the condensate discharge portion 722 is not present, the descending condensate is accumulated in the entrance of the exhaust duct 72. Thus, the condensate discharge portion 722 for discharging the condensate may be provided on the entrance of the exhaust duct 72, i.e. the lower side of the exhaust duct 72.

The condensate may be guided through the lower side of the tub 2 to a drain pipe 522 using the condensate discharge portion 722 to be discharged, or may be directly connected to the drain pipe 522 to be discharged.

Although FIG. 3 shows that the supply duct 71 has a predetermined inclination, the present disclosure is not limited thereto. That is, as long as the supply duct 71 extends to the rear side of the tub 2, the detailed shape of the supply duct 71 is not limited.

FIG. 2 shows that the induction-cooling-path connector 832 is formed around the center of the module cover 83, and FIG. 3 shows that the induction-cooling-path connector 832 is not formed around the center of the upper side of the induction module 8 but is provided on a side thereof.

That is, the induction-cooling-path connector 832 is provided on the module cover 83 to form a space where air for cooling the induction module 8 may pass. However, the induction-cooling-path connector is preferably provided so that air introduced through the induction-cooling-path connector 832 can effectively exchange heat with the entire induction module 8.

That is, as shown in FIG. 2, as long as the air is evenly dispersed to the front and rear sides of the induction module 8 to perform heat exchange even if the induction-cooling-path connector 832 is provided on the center, the induction-cooling-path connector 832 may be provided on the center of the module cover 83.

FIG. 4 is a partial enlarged sectional view of the tub according to the embodiment.

Referring to FIG. 4, the tub 2 may include a front surface 23, a rear surface, and a body 20 extending between the front surface 23 and the rear surface. The body may have the shape of an elongated cylinder.

The opening 21 (see FIG. 1) may be formed in the front surface 23. The opening 21 may be located in the central portion of the front surface 23. The front surface 23 may have the shape of a ring.

An inlet port 24 may be formed in the front surface 23. The inlet port 24 may be located in the outer side of the opening 21. The inlet port 24 may be located in an upper side of the opening 21. The inlet port 24 may face the front portion 30 of the drum 2.

The inlet port 24 may communicate with the outlet portion 711 of the supply duct 71.

The outlet portion 711 of the supply duct 71 may include an exit connected to the inlet port 24 of the tub 2. The exit of the outlet portion 711 may extend rearward. The outlet portion 711 may include a portion extending upward from the rearwardly extending exit.

The drum 2 may include a body 32 having the shape of an elongated cylinder. The drum 2 may include a hole 33 which is formed in the body 32. The air and the washing water may flow through the hole 33 between the inside and outside of the drum 2.

The drum 2 may include a drum front portion 30 connected to the front end of the drum body 32. The drum front portion 30 may extend in a direction from the drum body 32 toward the drum center and the front.

The drum front portion 30 may provide a drum opening 31. A user may put laundry through the drum opening 31 into the drum 2, and take the laundry out from the drum 2.

The drum front portion 30 may face the inlet port 24.

The drum front portion 30 may include an inclined surface 301 at a position corresponding to the inlet port 24. The inclined surface 301 may be inclined rearward in a direction from an inner side to an outer side. The inner end of the inclined surface 301 may overlap the inlet port 24 in the radial direction of the drum 3.

The drum front portion 30 may further include a portion extending from the inner end of the inclined surface 301 to the inner side of the drum 3 in a radial direction thereof. A boundary between the extending portion and the inner end of the inclined surface 301 may be formed at a position corresponding to the inlet port 24.

Thus, the air introduced into the inlet port 24 may be dispersed and flow between the drum body 32 and the tub body 20.

Thereby, the air introduced into the inlet port 24 may be guided between the drum body 32 and the tub body 20.

The drum front portion 30 may include an extending portion which extends forward to provide the drum opening 31.

The inlet port 24 may be located in back of the drum opening 31.

The gasket 4 may include a tubular body 40, a tub coupler 41 located in back of the body 40, and a cabinet coupler 42 located in front of the body 40.

The tub front surface 23 may include a forwardly extending coupler 26. The coupler 26 provides a tub opening 21.

The coupler 26 of the tub 2 may be inserted into the tub coupler 41 of the gasket 4. Therefore, the gasket 4 and the tub 2 may be coupled to each other.

Similarly, the cabinet 1 may be provided with a coupler which provides an opening in a front surface thereof, and the coupler may be inserted into the cabinet coupler 42 of the gasket 4. Therefore, the gasket 4 and the cabinet may be coupled to each other.

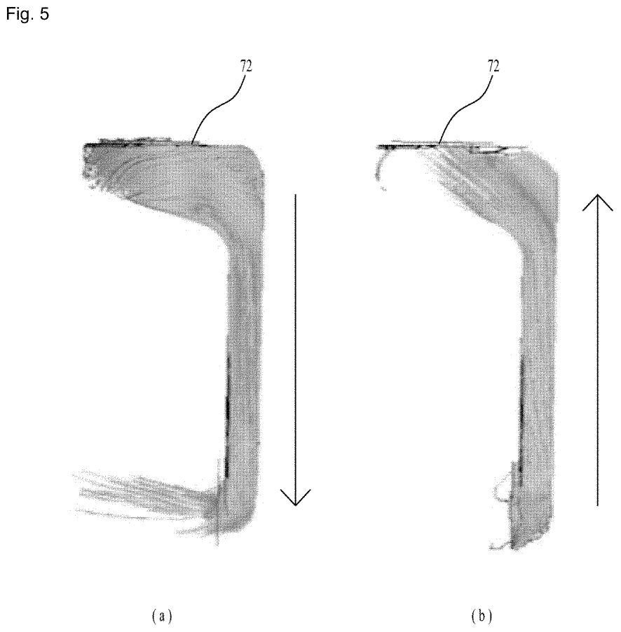

FIG. 5 is a diagram illustrating a flow in an exhaust duct according to the embodiment.

As described above, the exhaust duct 72 is provided to extend from the rear side of the tub 2 to the upper side of the tub 2.

The exhaust duct 72 may be provided to guide wet air discharged from the tub 2. A heat exchange portion 721 may be provided in the exhaust duct 72 to exchange heat with wet air.

Therefore, wet air discharged from the tub 2 may flow along the exhaust duct 72, so that condensate may be generated. Gravity acts on the condensate in a direction opposite to the flow direction of the wet air. Therefore, the condensate may flow down along the exhaust duct 72.

The condensate flowing down through the exhaust duct 72 may be less affected by gravity. In detail, the condensate flows down in the direction of gravity, but the influence of gravity may be reduced by the flow of wet air. Therefore, the scattering of the condensate toward the tub 2 may be minimized.

If the condensate is scattered and introduced into the tub 2, the temperature of the drum 3 heated by the induction module 8 may be lowered, so that efficiency may be reduced.

Therefore, air is circulated in a direction opposite to the gravity acting on the condensate, thus minimizing a possibility that the condensate is introduced into the tub 2 and scattered to the drum 3.

FIG. 5(a) and FIG. 5(b) show the simulation result of the inside of the exhaust duct 72 according to the circulating direction of the air.

In the case that the air circulating direction is equal to the gravity direction as shown in FIG. 5(a), water easily flows into the tub 2 when the condensate contacts the entrance of the exhaust duct 72.

In contrast, in the case that the air circulating direction is different from and opposite to the gravity direction as shown in FIG. 5(b), the scattering of water from the entrance of the exhaust duct 72 to the inside of the tub 2 may be minimized.

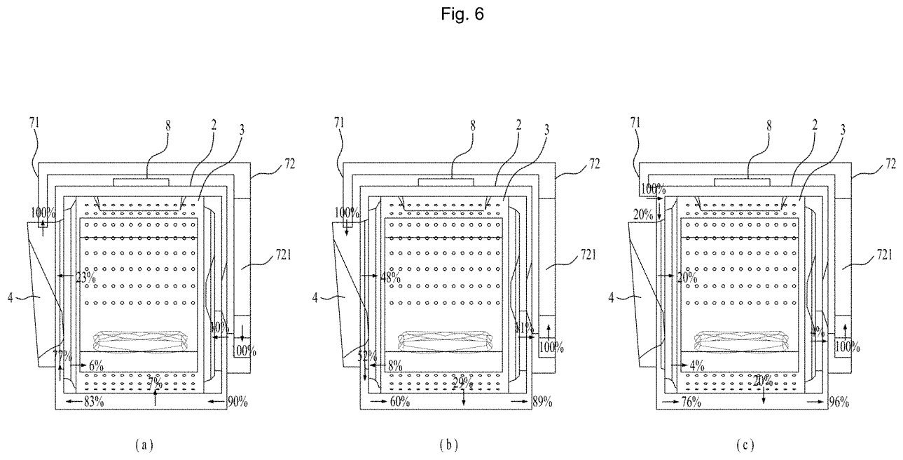

FIG. 6 is a diagram illustrating an air circulation structure according to the embodiment.

FIG. 6(a) is a diagram showing that air is introduced in a direction opposite to the above-described direction, i.e., through the exhaust duct 72 to the inside of the tub 2, FIG. 6(b) is a diagram showing that the air introduced in the same direction as the above-described direction, i.e., the air introduced through the inlet port 24 to the tub 2 flows into the drum 2, and FIG. 6(c) is a diagram showing that the upper surface of the front of the tub 2 and the supply duct 71 are connected such that air is introduced into a space between the drum 3 and the tub 2 while the air flows through the supply duct 71 to the inside of the tub 2.

Before the description, terms which will be described below will be defined.

Herein, an effective air volume (%) may be defined as a drum passing flow rate/a circulation air volume.

Herein, an effective work (%) may be defined as a drum transfer energy/induction module heating energy.

Herein, a temperature deviation may be defined as a standard deviation of temperature from the entrance of the drum to the rear surface.

TABLE 1

| | FIG. 6(a) | FIG. 6(b) | FIG. 6(c) |
|---|---|---|---|
| Effective air volume (%) | 23% | 48% | 24% |
| Effective work (%) | 38.7% | 37.3% | 39.4% |
| Temperature deviation | 2.4 | 5.6 | 0.85 |

Hereinafter, an example will be described with reference to Table 1 and FIGS. 6(a) to 6(c).

The flow rate passing through the drum 3 in which laundry or a drying object is accommodated is the largest in the case of FIG. 6(b). The reason is because the gasket 4 and the supply duct 71 are connected to each other in FIG. 6(b). Since the supply duct 71 is connected to the opening side of the gasket 4, air introduced into the drum 3 is the largest compared to other cases.

However, since the air is not heated by the induction module 8 in the case of being introduced through the gasket 4, it cannot be seen that the drying effect is greater than that of FIG. 6(c).

As for the effective work and the temperature deviation, the largest thermal energy is transmitted to the drum 3 and the temperature deviation in the front-rear direction of the drum 3 is small in the case of FIG. 6(c), so that drying may be evenly performed throughout the drum 3.

The same result as the above-described result is not always derived, and the numerical values shown in Table 1 and FIG. 6 may vary depending on the measurement method or measurement standard.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1-10. (canceled)

11. A clothing treatment apparatus comprising:
a cabinet;
a container located in the cabinet, the container including a front surface having an opening and an inlet port spaced from the opening, a rear surface having an exhaust port, and a body extending between the front surface and the rear surface;
a drum rotatably supported in the container;
an induction heater arranged at an outer surface of the body of the container, the induction heater being configured to heat the drum;
a supply duct arranged at an outer side of the container, the supply duct extending along the body of the container, the supply duct including an outlet portion in communication with the inlet port of the container, the outlet portion having an exit portion extending rearward and connected to the inlet port of the container; and
an exhaust duct connected to the supply duct, the exhaust duct being in communication with the exhaust port.

12. The clothing treatment apparatus of claim 11, wherein the inlet port of the container is located above the opening of the container.

13. The clothing treatment apparatus of claim 12, wherein the induction heater is located at an upper side of the body of the container.

14. The clothing treatment apparatus of claim 11, wherein the drum comprises:
a drum body;
at least one hole formed in the drum body; and
a drum front portion extending from a front end of the drum body, the drum front portion having a drum opening.

15. The clothing treatment apparatus of claim 14, wherein the inlet port of the container faces the drum front portion.

16. The clothing treatment apparatus of claim 15, wherein the drum front portion comprises an inclined surface extending downward and forward from the drum body at a position corresponding to the inlet port of the container.

17. The clothing treatment apparatus of claim 14, wherein the drum front portion comprises an extending portion extending forward from the drum body to provide the drum opening, and
wherein the inlet port of the container is located rearward of the drum opening.

18. The clothing treatment apparatus of claim 11, wherein the exhaust port of the container is located at a lower side of the rear surface of the container, and wherein the exhaust duct extends upward from the exhaust port.

19. The clothing treatment apparatus of claim 18, further comprising a heat exchange portion arranged in the exhaust duct, the heat exchange portion being configured to absorb heat from air discharged from the container.

20. The clothing treatment apparatus of claim 19, further comprising a drain portion configured to drain water discharged from the container and condensate formed by the heat exchange portion.

21. The clothing treatment apparatus of claim 20, wherein the drain portion includes:
a drain pump;
a first drain pipe connected between the drain pump and the container; and
a second drain pipe connected between the drain pump and an exterior of the cabinet.

22. The clothing treatment apparatus of claim 11, further comprising a ventilation portion configured to generate air flow from the exhaust duct toward the supply duct.

23. A clothing treatment apparatus comprising:
a cabinet;
a container located in the cabinet, the container including a front surface having an opening and an inlet port spaced from the opening, a rear surface having an exhaust port, and a body extending between the front surface and the rear surface;
a drum rotatably supported in the container;
an induction heater arranged at an outer surface of the body of the container, the induction heater being configured to heat the drum, the induction heater having a heater cover and a connector;
a supply duct arranged at an outer side of the container, the supply duct extending along the body of the container, the supply duct including an outlet portion in communication with the inlet port of the container;
an exhaust duct connected to the supply duct, the exhaust duct being in communication with the exhaust port; and
a ventilation portion connecting the exhaust duct to the supply duct and the connector of the inductor heater cover.

24. The clothing treatment apparatus of claim 23, further comprising a heat exchange portion arranged in the exhaust duct, the heat exchange portion being configured to absorb heat from air discharged from the container.

25. The clothing treatment apparatus of claim 23, wherein the outlet portion comprises an exit portion extending rearward and connected to the inlet port of the container.

26. The clothing treatment apparatus of claim 23, wherein the inlet port of the container is located above the opening of the container.

27. The clothing treatment apparatus of claim 23, wherein the induction heater is located at an upper side of the body of the container.

28. The clothing treatment apparatus of claim 23, wherein the drum comprises:
a drum body;
at least one hole formed in the drum body; and
a drum front portion extending from a front end of the drum body, the drum front portion having a drum opening.

29. The clothing treatment apparatus of claim 23, wherein the exhaust port of the container is located at a lower side of the rear surface of the container, and wherein the exhaust duct extends upward from the exhaust port.

30. The clothing treatment apparatus of claim 29, further comprising a drain portion configured to drain water discharged from the container and condensate formed by the heat exchange portion.
